(19) United States
(12) Patent Application Publication
(10) Pub. No.: US 2010/0222996 A1
(43) Pub. Date: Sep. 2, 2010

(54) Dual Representation of an Address in a Database

(75) Inventors: Michael L. Weiland, Gurnee, IL (US); Paul T. Ford, Oak Park, IL (US); Suzanne M. McGrath, Chicago, IL (US); Vojislav Samsalovic, Chicago, IL (US)

Correspondence Address: NAVTEQ NORTH AMERICA, LLC, 425 West RANDOLPH STREET, SUITE 1200, PATENT DEPT, CHICAGO, IL, 60606, US

(73) Assignee: NAVTEQ North America, LLC, Chicago, IL (US)

(21) Appl. No.: 12/395,013

(22) Filed: Feb. 27, 2009

(51) Int. Cl. G01C 21/36; G06F 17/30

(52) U.S. Cl. 701/200; 707/E17.018

(57) ABSTRACT

A data representation for an address is disclosed. The address is represented by two links. The first link is an addressed link and the second link is a routing link. The addressed link is the link associated with the address. The routing link is the link associated with a travel-to location for the address. The address may also be represented by two points. The first point is a display point and the second point is a routing point. The display point is used for displaying an address location on a map display. The routing point is used for routing a user of a navigation device to the appropriate point on a road network or pedestrian pathway for the address location.

### FIELD

The present invention relates generally to providing navigation guidance, and more particularly, relates to representing an address in a database to provide separation of routing and addressing.

### BACKGROUND

Various technologies have been developed that provide navigation and map-related services. For example, vehicle navigation systems can determine where a vehicle is located and provide directions to travel to a desired destination. Also, Internet sites are available that provide maps, directions for traveling to a desired destination from a specified starting point, and other map-related services. Further, hand-held devices are available that can determine one's position and provide a map of one's surroundings. For purposes of this specification, a navigation system is any device that can provide navigation and/or map-related services.

In order to provide these services, navigation systems may use geographic data. The geographic data may be in the form of one or more geographic databases that include data representing physical features in the geographic region. The geographic database includes information about the represented geographic features, such as one-way streets, position of the roads, speed limits along portions of roads, address ranges along the road portions, turn restrictions at road intersections, direction restrictions, such as one-way streets, and so on. Additionally, the geographical database may include information about pedestrian pathways, such as whether the pathway is paved or unpaved, whether the pathway is wheel chair accessible, and whether crosswalks exist. The geographic data may also include data associated with points of interest, such as restaurants, hotels, airports, gas stations, stadiums, police stations, and so on.

Additionally or alternatively, the navigation system may use a location code assigned to a geographic location represented in the geographic database. A location content management system assigns the location code, which then acts as a link between the geographic location and location content stored in a database in the location content management system. Location content is any information associated with a location that describes attributes of the location. The information may be static content (i.e., does not change frequently), such as a street address, a telephone number, a fax number, and hours of operation. The information may be dynamic content (i.e., changes frequently), such as gas prices, weather reports, air travel status, and traffic reports. The information stored in the location content database may be in any format, including text, two-dimensional images, three-dimensional images, video, multimedia, and so on.

While navigation systems provide useful information to users, there continues to be room for new features and improvements. One area in which there is room for improvement relates to how to represent an address in a geographic database and/or a location content database. Generally, an address consists of a number, a street, and administrative information, such as city, state, zip code, and country. In a typical geographic database, an address is associated with a link (sometimes referred to as a segment). A link represents a portion of a road network or a pedestrian pathway in a geographic area. The address information associated with a link includes data identifying an address range and a side of the link.

Many users of a navigation system prefer to be routed to an exact location for a specific address rather than to a general area defined by the address range. While it seems like associating the specific address to a point on a map (e.g., latitude and longitude) would be sufficient, problems exist with this address representation. Accordingly, it would be beneficial to provide a more accurate data representation of an address that overcomes the problems associated with an address range data representation and a single point data representation.

### SUMMARY

A method and system for representing addresses in a database is disclosed. An address is represented by two links. The first link is an addressed link and the second link is a routing link. The addressed link may be different than the routing link. Alternatively, the addressed link may be the same link as the routing link. The address may also be represented by two points, a display point and a routing point. The display point is used for displaying an address location on a map display. The routing point is used for routing a user to the appropriate point on a road network or pedestrian pathway for the address location. As a result of this address representation that separates addressing from routing, a user of navigation and/or map-related services receives more accurate information regarding an address of interest.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a navigation system, according to an example;

FIG. 2 is a block diagram of some data that may be stored in the geographic database depicted in FIG. 1, according to an example;

FIG. 3 is a block diagram of some data that may be stored in the geographic database depicted in FIG. 1, according to another example;

FIG. 4 is a pictorial representation of point addresses, according to an example;

FIG. 5 is a pictorial representation of point addresses, according to another example; and

FIG. 6 is a pictorial representation of a point address, according to another example.

### DETAILED DESCRIPTION

### I. NAVIGATION SYSTEM

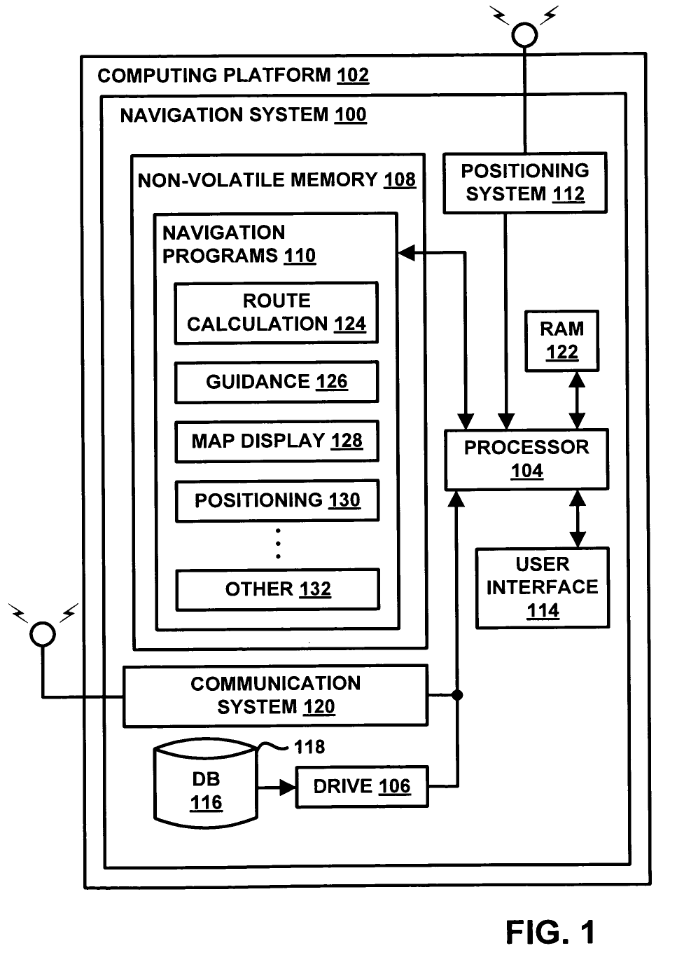

FIG. 1 is a block diagram of a navigation system 100 associated with a computing platform 102, such as a personal digital assistant (PDA), mobile telephone, or any other computer. The navigation system 100 is a combination of hardware and software components. In one embodiment, the navigation system 100 includes a processor 104, a drive 106 connected to the processor 104, and a non-volatile memory storage device 108 for storing navigation application software programs 110 and possibly other information.

The navigation system 100 also includes a positioning system 112. The positioning system 112 may utilize GPS-type technology, a dead reckoning-type system, or combinations of these or other systems, now known or developed in the future. The positioning system 112 may include suitable sensing devices that measure the traveling distance, speed, direction, orientation, and so on. The positioning system 112 may also include a GPS system. The positioning system 112 outputs a signal to the processor 104. The navigation application software programs 110 that run on the processor 104 may also use the signal from the positioning system 112 to determine the location, direction, and orientation of the computing platform 102.

The navigation system 100 also includes a user interface 114 that allows the end user to input information into the navigation system 100 and obtain information from the navigation system 100. The input information may include a request for navigation and map-related features and functions of the navigation system 100. For example, the user may select a destination to obtain route guidance and/or a map display. To provide these features and functions, the navigation system 100 uses a geographic database 116 stored on a storage medium 118.

In one embodiment, the storage medium 118 is installed in the drive 106 so that the geographic database 116 can be read and used by the navigation system 100. In one embodiment, the geographic database 116 may be a geographic database published by NAVTEQ North America, LLC of Chicago, Ill. The storage medium 118 and the geographic database 116 do not have to be physically provided at the location of the navigation system 100. In alternative embodiments, the storage medium 118, upon which some or the entire geographic database 116 is stored, may be located remotely from the rest of the navigation system 100 and portions of the geographic data provided via a communication system 120, as needed.

In some navigation systems, the navigation application software programs 110 load from the non-volatile memory storage device 108 into a random access memory (RAM) 122 associated with the processor 104. The processor 104 also receives input from the user interface 114. The navigation system 100 uses the geographic database 116 stored on the storage medium 118, possibly in conjunction with the outputs from the positioning system 112 and the communications system 120, to provide various navigation features and functions.

The navigation application software programs 110 may include separate applications (or subprograms) that provide the various navigation-related features and functions. The navigation functions and features may include route calculation 124 (wherein a route from an origin to a destination is determined), route guidance 126 (wherein detailed directions are provided for reaching a desired destination), map display 128, and positioning 130 (e.g., map matching). Other functions and programming 132 may be included in the navigation system 100.

The navigation application software programs 110 may be written in a suitable computer programming language such as C, although other programming languages, such as C++ or Java, are also suitable. All of the components described above may be conventional (or other than conventional) and the manufacture and use of these components are known to those of skill in the art.

### II. GEOGRAPHIC DATABASE

A. Same Link Used for Addressing and Routing

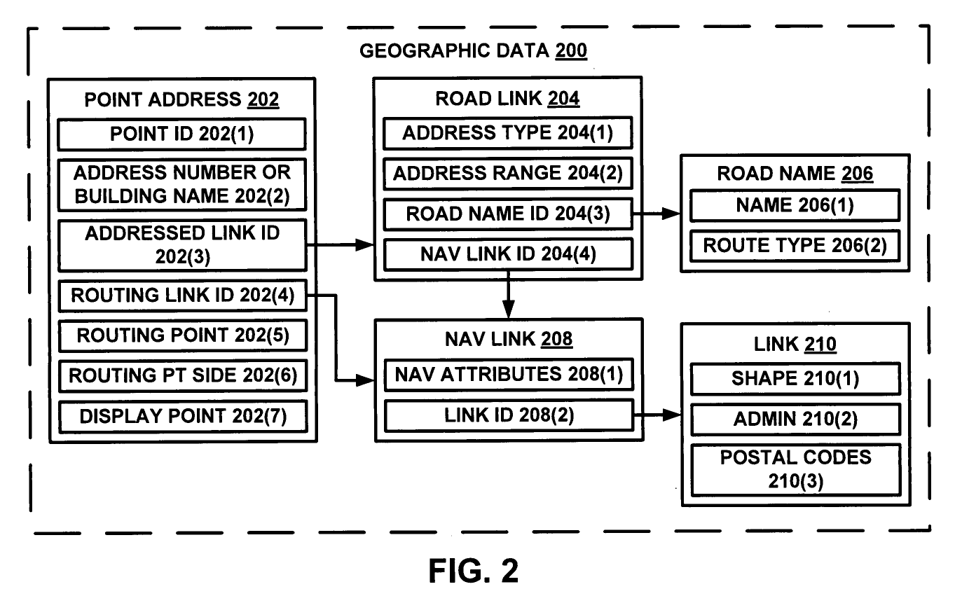

FIG. 2 is a block diagram of geographic data 200 that may be stored in the geographic database 116 depicted in FIG. 1. The geographic data 200 includes information about point addresses in one or more geographic regions or coverage areas. A point address is a data representation of an address that allows for a real-world map display of an address point (e.g., building bearing the address) and an optimal routing point for this address. In the example depicted in FIG. 2, the same link is used for both addressing and routing.

The geographic data 200 includes a point address record 202 for each point address. The point address record 202 includes a point identifier 202(1) by which the record can be identified in the geographic database 116.

The point address record 202 also includes data 202(2) identifying either an address number or a building name. Alternatively, the data 202(2) may identify an address number and a building name. The address number may include numeric and non-numeric characters. For example, the address number may be “2209,” “100A,” “5-BIS,” “5316 1/2,” and so on. Additionally, the data 202(2) may include more than one building name, such as the “Boeing Building” and the “425 Building,” each referring to the building located adjacent to Riverfront Plaza between Randolph Street and Washington Street in Chicago.

The data 202(2) may also include historical address numbers and building names. Additionally, the data 202(2) may include future address numbers and building names. For example, if a map vendor knows that a building will renamed next year when the building changes owner, a new building name along with a date/time when the new name takes effect may be included in the data 202(2).

The point address record 202 also includes data 202(3) that identifies an addressing relationship associated with an addressed link and data 202(4) that identifies a routing relationship associated with a routing link. The addressed link identifier 202(3) references a road link record 204. The road link record 204 includes data 204(1) regarding address type. The address type data 204(1) may identify whether an addressed location is a residential location or a commercial location. The address type data 204(1) may also identify whether the address has changed over time (e.g., road name change).

The road link record 204 also includes data 204(2) that identifies an address range along the addressed link. The address range attribute 204(2) may include data identifying the first and last street number (or other identifying non-numeric characters) for each of the two sides of a road. Additionally, if a numeric numbering system is used, the address range attribute 204(2) may include data identifying which side of the road has even numbered addresses and which side of the road has odd numbered addresses.

The road link record 204 also includes data 204(3) that identifies a road name record 206. The road name record 206 includes a name attribute 206(1) that identifies the name of the road of which the addressed link is a part (e.g., Main, Broadway, First). The road name record 206 also includes a route type attribute 206(2) that identifies the type of road associated with the addressed link (e.g., street, avenue, drive). The route type attribute 206(2) may also include data that identifies a type of road shield associated with the addressed link (e.g., interstate, state highway, county road).

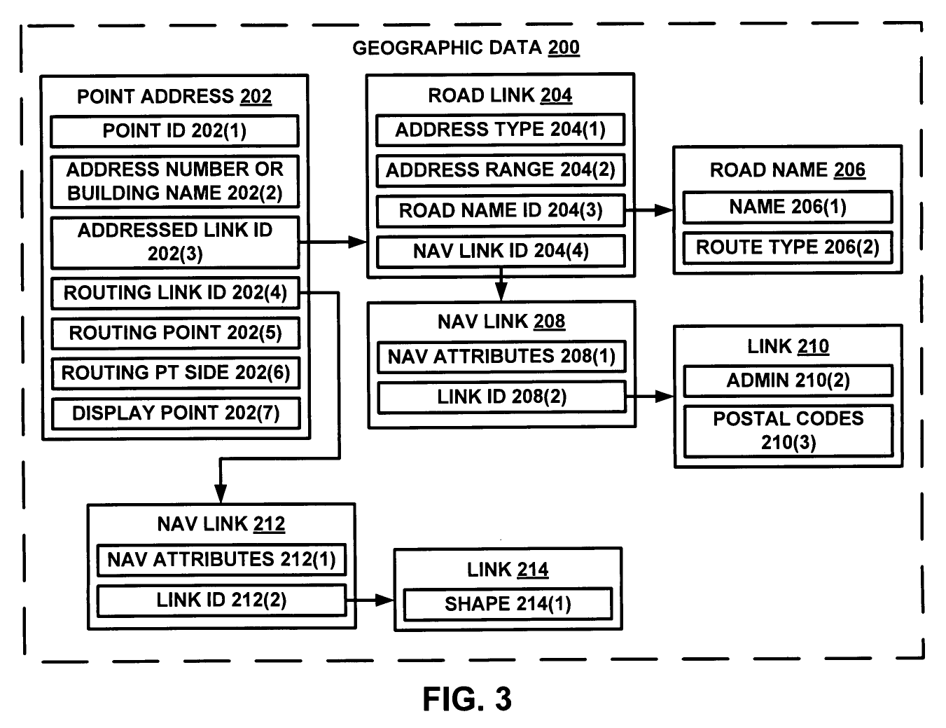

The road link record 204 may also include data 204(4) that identifies a navigation link record 208. In this example where the same link is used for both addressing and routing, the data 204(4) that identifies the navigation link record 208 is the same data 202(4) in the point address record 202. In the example described with reference to FIG. 3, different road links are used for addressing and routing.

The navigation link record 208 includes data 208(1) that describes navigable attributes for each of the two sides of the link. For example, the data 208(1) may identify the permitted direction of vehicular travel on the link. For example, the link may represent a portion of a road network in which travel is permitted in both directions. Alternatively, the link may represent a portion of a road network allowing only one-way travel. The data 208(1) identifies whether the link allows bi-directional travel or unidirectional travel, and if unidirectional, the data 208(1) also identifies the allowed direction of travel.

As another example, the data 208(1) may identify a rank of the link. A rank of a link may correspond to its functional class. For example, links having a rank of “4” may include high volume, controlled access roads, such as expressways and freeways. Links having a rank of “3” may be high volume roads with few speed changes, but are not necessarily controlled access roads. The lower ranked roads handle corresponding lower volumes and generally have more speed changes or slower speeds. Links having a rank of “0” handle the lowest volumes, including side streets and alleyways.

As yet another example, the data 208(1) may identify whether the link is part of a controlled access road (such as an expressway), a ramp to a controlled access road, a bridge, a tunnel, a toll road, and so on.

The navigation link record 208 also includes data 208(2) that identifies a link record 210. Because the same link is used for addressing and routing in this example, the addressed link and the routing link are both associated with the data located in the link record 210. The link record 210 includes data 210(1) that may be used to represent the shape of the routing link. The shape data 210(1) includes geographic coordinates (e.g., the latitude, longitude, and optionally altitude) of endpoints of the link. The shape data 210(1) also includes geographic coordinates for one or more shape points located between the endpoints of the link.

The link record 210 also includes data 210(2) regarding administrative attributes associated with the link. For example, the administrative attribute data 210(2) may include city, state, and country, for each of the two sides of a road. The link record 210 also includes data 210(3) that identifies postal codes (e.g., zip codes) associated with the link for each of the two sides of a road.

The point address record 202 also includes routing point data 202(5) identifying a location (e.g., latitude, longitude, and optionally altitude) of a routing point. The location of the routing point is an approximate position along the link to which a vehicle is guided to reach the address. Additionally or alternatively, the routing point may be the location of a starting point as opposed to a destination point.

For example, the location data for the routing point attribute 202(5) may identify a driveway, a parking lot, a walkway, or another appropriate point associated with the address. The location data for the routing point attribute 202(5) may be offset (e.g., approximately 5 meters) from the road centerline to enable visualization of which side of the road the address lies.

The point address record 202 also includes routing point side data 202(6) identifying a side (e.g., left, right) of the link. The routing point side data 202(6) may be useful during route calculation 124, route guidance 126, map display 128, and positioning 130.

The point address record 202 also includes data 202(7) identifying a display point. The display point attribute 202(7) includes location data (e.g., latitude, longitude, and optionally altitude) for a display point. Preferably, the location data for the display point attribute 202(7) identifies a nominal center of a polygonal area of a parcel associated with the address. Alternatively, the location data for the display point attribute 202(7) may identify a building centroid, a building entrance, or another appropriate point associated with the address.

It is understood that a different organization of the geographic data 200 than as shown in FIG. 2 may be used. For example, the point address record 202 may also include street name and administrative information. However, to avoid redundant data storage, the point address record 202 preferably does not include this data as the street name and administrative data can be obtained from the road name record 206 and the link record 210. Additionally, each of the data records 202-210 depicted in FIG. 2 may include other data entities, such as a speed range or speed limit attribute. The geographic data 200 may also include other data records not shown in FIG. 2.

The point address record 202 may also be used to identify one or more points of interest located adjacent to the addressed link and/or the routing link. In addition to the data records shown in FIG. 2, the geographic data 200 may include a points of interest record that includes data regarding type (e.g., restaurant, hotel, city hall, police station, historical marker, ATM, golf course, etc.), telephone numbers, hours of operation, and other attributes of a point of interest.

B. Different Link Used for Addressing and Routing

FIG. 3 is a block diagram of geographic data 200 that may be stored in the geographic database 116 depicted in FIG. 1, according to another example. In this example, the addressed link and the routing link are different. As a result, the addressed link identifier 202(3) has an addressing relationship with link record 210 (“addressed link”), while the routing link identifier 202(4) has a routing relationship with link record 214 (“routing link”).

In many cases, the position of an addressed location in the real world is not the same as the travel-to position. For example, large complexes, such as shopping malls and hospitals, may have many unnamed roads providing access to different parts of the complex. However, the complex may have a single address associated with a named road. If a user of a navigation system needs route guidance to a hospital in an emergency, the user needs route guidance to the emergency room entrance of the hospital located on an internal road and not to the addressed location, which may be quite a distance away from the emergency room entrance.

The addressed link is used when a user of the navigation system 100 performs destination selection via the user interface 114. The navigation system 100 obtains the complete address using data in the address number and/or building name attribute 202(2) in the point address record 202, data in the road name attribute 206(1) in the road name record 206 (via data in the road name identifier attribute 204(3) in the road link record 204 and data in the addressed link identifier attribute 202(3) in the point address record 202), and data in the administrative attribute 210(2) and the postal code attribute 210(3) in the link record 210 (via data in the link identifier attribute 208(2) in the navigation link record 208 and data in the navigation link identifier attribute 204(4) in the road link record 204). The addressed link may be used with other navigation system functions as well.

The routing link is used when the navigation system 100 performs route calculation 124, route guidance 126, map display 128, and/or positioning 130. The routing link may be used with other navigation system functions as well. The navigation system 100 uses data in the routing link identifier attribute 202(4) to create a routing relationship with a second navigation link record 212. Similar to the first navigation link record 208, the second navigation link record 212 includes data 212(1) that describes navigable attributes for each of the two sides of a link identifiable by using a link identifier attribute 212(2). The link identifier attribute 212(2) identifies the second link record 214.

FIG. 3 depicts the first link record 210 having administrative attributes 210(2) and postal code attributes 210(3), and the second link record 214 having shape attributes 214(1). This depiction shows that shape data is not necessary to perform destination selection and that administrative and postal code data is not necessary to perform route calculation 124, route guidance 126, map display 128, and/or map positioning 130. However, it is understood that the link records 210, 214 may each include all three attributes (shape, administrative, postal codes) as well as other data attributes.

The navigation system 100 may also use data in the routing point attribute 202(5), the routing point side attribute 202(6), and the display point attribute 202(7) while performing one or more of route calculation 124, route guidance 126, map display 128, positioning 130, and other navigation and map-related functions. For example, the navigation system 100 may use data in the routing point attribute 202(5) and the routing point side attribute 202(6) to perform route calculation 124, route guidance 126, and positioning 130. As another example, the navigation system 100 may use data in the display point attribute 202(5) to perform map display 128.

### III. POINT ADDRESS EXAMPLES

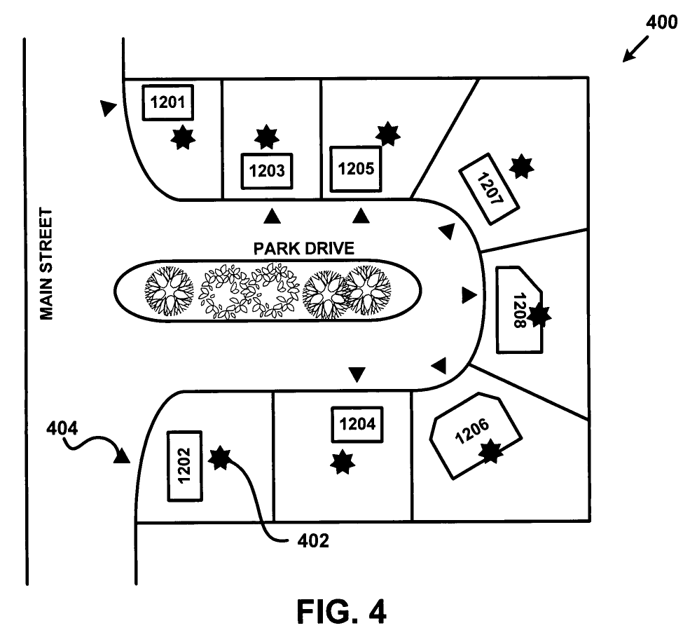

FIG. 4 is a pictorial representation of a residential neighborhood 400. Each parcel in the neighborhood 400 is associated with a link (i.e., addressed link) for Park Drive based on address information (i.e., addresses 1201-1208 Park Drive). Each address has a display point 402 (star shape) and a routing point 404 (triangle shape). In this example, the display point 402 is located at the approximate center point of the parcel, while the routing point 404 is located to provide route guidance to a driveway associated with the parcel.

For 1201 and 1202 Park Drive, the routing points 404 are associated with a link associated with Main Street (i.e., routing link). A user requesting a map of 1202 Park Drive receives a map display identifying 1202 Park Drive at the display point 402. The map display may include any combination of 2D views, 3D views, photographs, videos, and other images. A user requesting routing directions to 1202 Park Drive receives route guidance to the appropriate routing point 404 on Main Street. The route guidance may include any combination of text, audio, and images.

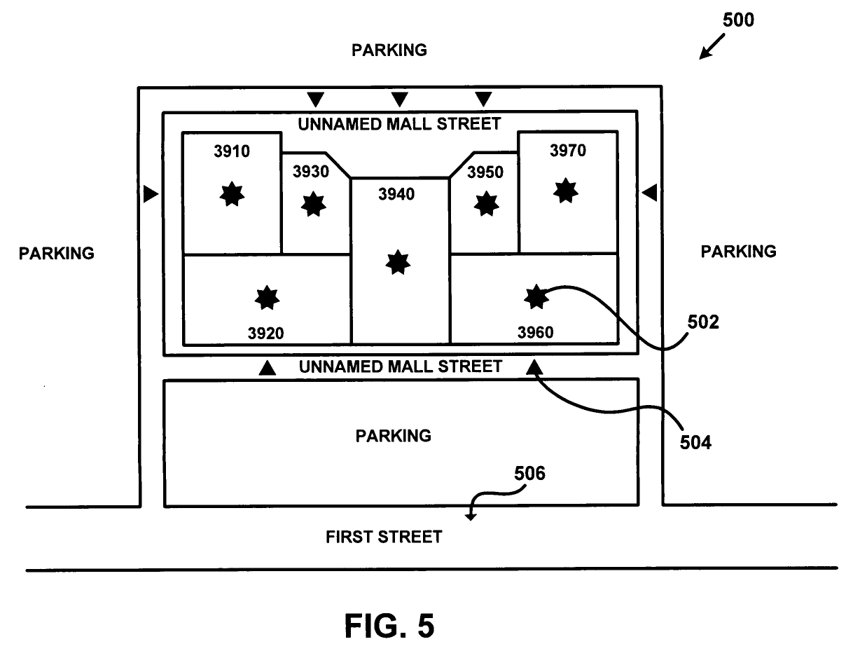

FIG. 5 is a pictorial representation of a shopping mall 500. Each store in the shopping mall 500 is associated with a link 506 (i.e., addressed link) for First Street based on address information (i.e., 3910-3970 First Street). Each address has a display point 502 (star shape) and a routing point 504 (triangle shape). In this example, the display point 502 is located at the approximate center point of the store footprint, while the routing point 504 is located to provide route guidance to the store entrance.

A user requesting a map of 3960 First Street receives a map display identifying 3960 First Street at the display point 502. The map display may include any combination of 2D views, 3D views, photographs, videos, and other images. A user requesting routing directions to 3960 First Street receives route guidance to the appropriate routing point 504 on one of the unnamed streets (i.e., routing link) surrounding the mall. The route guidance may include any combination of text, audio, and images.

### IV. OTHER EXAMPLES

While the examples above were described with respect to a road network and links that are used to represent the road network, it is understood that the dual address representation may be used in pedestrian navigation systems as well. For example, a dual address representation may be used with addressable buildings along pedestrian pathways.

It is also understood that many other systems may use a dual address representation of an address in a database. For example, a location content management system may use the dual address representation. The display point may define the actual location associated with a location code in terms of geographic coordinates (latitude, longitude, and optionally altitude). The routing point may define the travel-to location associated with the location code in terms of geographic coordinates (e.g., latitude, longitude, and optionally altitude). In this example, one or more location content sources may provide the display point and/or the routing point to the location content management system. The location content management system may store each display point and/or routing point in a location content database.

Additionally, the location content management system may use the dual address representation for locations within buildings by extending the address to include floor, suite, room, and/or office information. An example extended address is 425 West Randolph, floor 12, office 12D125, Chicago, Ill., 60606. The display point may be located in the center of the office, while the routing point may be located at the door of the office.

Additionally, more than one routing point and/or display point may be associated with an address. For example, a business may have a visitor entrance, an employee entrance, a handicap entrance, and a loading dock. A routing point may be assigned to each of these entrances. The user may receive route guidance to the appropriate routing point. For example, a delivery truck driver may be routed to the loading dock.

As another example, a building may have two tenants, each having their own entrance to the building. Each entrance may have its own routing point as described in the previous example. Additionally, each entrance may have its own display point so that a visitor to Company A receives an image of the east facing side of the building, while a visitor to Company B receives an image of the north facing side of the building.

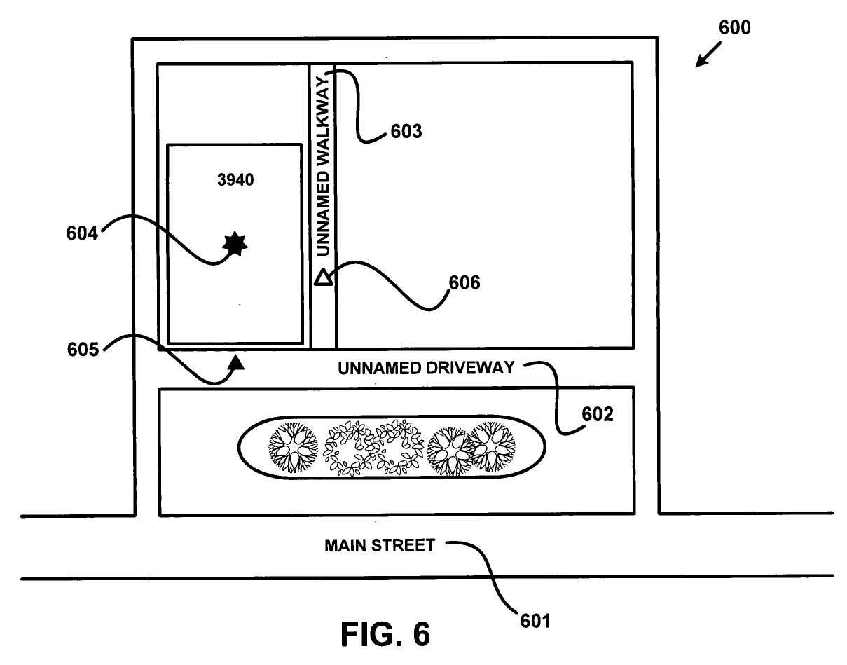

FIG. 6 is a pictorial representation of an area 600 where a walk-to point is different than a drive-to point for a building. In this example, the building has the address 3940 Main Street. The building address is associated with the addressed link 601 that represents a portion of Main Street. The building address also has a routing relationship with two unnamed routing links 602, 603. The routing link 602 is part of a road network, while the routing link 603 is part of a pedestrian network.

The building address is also associated with a display point 604, a drive-to routing point 605, and a walk-to routing point 606. The display point 604 is located at a building centroid. The drive-to routing point 605 is located at an appropriate point on the road network to route a driver. The walk-to routing point 606 is located at an appropriate point on the pedestrian network to route a pedestrian.

By using an address representation that separates addressing from routing, a user of a navigation system (e.g., an in-vehicle navigation system, a hand-held navigation system, a mobile telephone, a personal computer, and so on) receives more accurate information regarding the location of the address and how to travel to the address. The dual address representation is especially useful when a building with a street address is best reached using a road with a different name or no street name. Additionally, the display and routing to points of interest may be enhanced.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A point address record that includes data for representing an address of a building in a geographic area, comprising:
a first identifier attribute for identifying data associated with an addressed link, wherein the addressed link is a link representing a portion of a road associated with the address;
a second identifier attribute for identifying data associated with a routing link, wherein the routing link is a link representing a portion of a road associated with a travel-to point for the address; and
data representing at least one of an address number and a building name.

2. The point address record of claim 1, further comprising data representing a display point for displaying the location of the address on a map display.

3. The point address record of claim 2, wherein the display point is located substantially at a center of a parcel associated with the address.

4. The point address record of claim 2, wherein the display point is located substantially at a center of a footprint of a building associated with the address.

5. The point address record of claim 2, wherein the display point is located substantially at an entrance of a building associated with the address.

6. The point address record of claim 1, further comprising data representing a routing point located along the routing link.

7. The point address record of claim 6, further comprising data representing a routing point side indicating on which side of the routing link is the routing point.

8. The point address record of claim 1, wherein the addressed link and the routing link are different links in a road network.

9. A method for representing an address in a geographical database for use by a navigation system, comprising:
identifying an addressed link for an address;
identifying a routing link for the address;
storing data associated with the addressed link and the routing link in a geographic database; and
representing the address using the data associated with the addressed link and the routing link.

10. The method of claim 9, wherein the navigation system uses the data associated with the addressed link during destination selection and the navigation system uses the data associated with the routing link to provide navigation features selected from the group consisting of route calculation, route guidance, map display, and map matching.

11. The method of claim 9, further including identifying a display point and storing data associated with the display point in the geographic database.

12. The method of claim 11, wherein the navigation system uses the display point data during map display.

13. The method of claim 9, further including identifying a routing point and a routing point side, and storing data associated with the routing point and the routing point side in the geographic database.

14. The method of claim 13, wherein the navigation system uses the routing point data and routing point side data during route guidance.

15. A method for providing navigation guidance to an end-user of a navigation system, comprising:
receiving from the end-user of a navigation system a request for guidance, wherein the request includes address information and guidance type;
if the request identifies map display as the guidance type, retrieving geographic data from a database representing a display point;
if the request identifies routing as the guidance type, retrieving geographic data from the database representing a routing point;
providing the end-user with at least one of a map display using the display point data and route guidance using the routing point data.

16. The method of claim 15, wherein the request further includes a location code.

17. The method of claim 15, wherein the database is a map database used by the navigation system.

18. The method of claim 15, wherein the database is a location content database used by a location content management system.

19. The method of claim 15, wherein the map display presents at least one of a 2D view, a 3D view, a photograph, and a video.

20. The method of claim 15, wherein the route guidance is provided in at least one of text, audio, and images.
